(19) United States
(12) Patent Application Publication
(10) Pub. No.: US 2014/0315531 A1
(43) Pub. Date: Oct. 23, 2014

(54) SYSTEM & METHOD FOR ENABLING OR RESTRICTING FEATURES BASED ON AN ATTENTION CHALLENGE

(71) Applicants: Donald Joong, Montreal (CA); Ganish Katyal, Ville Saint Laurent (CA)

(72) Inventors: Donald Joong, Montreal (CA); Ganish Katyal, Ville Saint Laurent (CA)

(21) Appl. No.: 13/864,901

(22) Filed: Apr. 17, 2013

(51) Int. Cl. H04M 1/725; H04W 4/02

(52) U.S. Cl. CPC H04M 1/72577; H04W 4/027
USPC 455/418; 455/26.1

(57) ABSTRACT

An attention challenge is provided to a user to ensure that while a mobile device is in motion, the user is not operating a vehicle. Failure at the attention challenge results in a restricted set of features so that the user is not able to interact with the mobile device in a manner that would impair driving.

### TECHNICAL FIELD

This disclosure relates generally to differentiating between a driving and a driven state and restricting features of a mobile device in response to this differentiation.

### BACKGROUND

As mobile communication devices have become more prevalent, their usage has resulted in problems that were otherwise unanticipated during their development. Some of these problems relate to issues of etiquette, while others can cause physical danger. Among the latter set of problems is the use of mobile communication devices, and other computing devices, during the operation of a motor vehicle.

Many jurisdictions have passed laws prohibiting the use of handheld devices during the operation of motor vehicle. The intent is not simply to prevent the driver of a car from being distracted by talking on the phone, but also to prevent other handheld use of the device, including the sending and reading of messages, such as SMS and email.

It has been observed that simply passing legislation to prohibit an activity is insufficient to prevent the activity from taking place. Enforcement of distracted driving legislation is difficult. A driver may not hold a mobile device at a height to allow other vehicles to see that he is using the device.

Carriers, such as Sprint, have created applications that make use of the sensors in mobile devices, such as GPS system. As illustrated in FIG. 1, these applications use the sensors to determine that a mobile device is travelling in step 50. If the measured speed is determined to be in excess of a preset threshold velocity in step 52, the application then prevent access to certain features of the device as shown in step 56. Typically if the speed threshold has not been exceeded the system will wait for a predetermined amount of time and then restart the verification process. In one example of such systems, upon exceeding a speed threshold, the ability to use the phone as a handset is locked, but the ability to use the phone as a speakerphone is permitted. In another example, the ability to compose a message using the keyboard of the mobile device is prevented, but the ability to make use of voice transcription services would not be.

Some manufacturers of mobile devices have included so-called Driving Modes that provide similar locking of features when the Driving Mode has been enabled. The enablement of the driving mode typically relies on an external cue, such as a user initiating the mode, or the device pairing to a known Bluetooth device that is associated with driving, such as a car.

Both of the above solutions require a use to initiate their use, either through the configuration of a device, a specific indication, or through the installation of an application. Sadly, the users most likely to do any of these activities likely correspond to the users least likely to use the mobile device while driving. It is difficult to require carriers or mobile device manufacturers to force the use of these systems, as there are a number of scenarios in which users should not be prevented from using their mobile devices. When a user is on a bus or a train, any meaningful speed threshold would be exceeded, but the user should not be prevented from using the device. Similarly, if there are two mobile devices in a car, one being operated by the driver and another by a passenger, only the device of the driver needs to be restricted for safety.

Because of the inability of the device to differentiate between a state in which the operator is driving and a state in which the operator is being driven, the inconvenience caused to a non-driving operator when a mistake is made prevents legislation from being introduced or passed that would require the use of automated restrictions on features. One skilled in the art will appreciate that obviating these disadvantages of the prior art would likely allow for safer roads.

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of restricting access to a mobile device in travel, to be carried out at the mobile device. The method comprises the steps of receiving an indication that the mobile device is subject to travel; issuing an attention challenge to the user of the mobile device to determine if the device is in a driving state or a driven state; and modifying restrictions on the mobile device in accordance with the determined state of the device.

In an embodiment of the first aspect of the present invention, the step of receiving an indication includes receiving the indication from a mobile device sensor. In one such embodiment, the step of receiving an indication includes receiving an indication that the device has connected to a vehicle and optionally, the indication is an indication that the mobile device has connected to a vehicle using a Bluetooth connection. In another of such embodiments, the step of receiving an indication includes receiving an indication from the user that the mobile device is subject to travel. In a further such embodiment, the step of receiving includes receiving an indication that a threshold speed has been exceeded by the mobile device, where optionally the step of receiving includes computing a speed in accordance with location information. In another embodiment of the first aspect of the present invention, the step of receiving an indication includes receiving the indication from a network entity over a radio access network. In a further embodiment, the method further includes the step of determining that an application subject to restrictions has been launched. In another embodiment, the step of issuing an attention challenge includes displaying instructions to the user to provide an input to the mobile device and in accordance with a received input from the user determining the device to be in a driven state where optionally the step of displaying instructions to the user includes displaying intentionally distorted text to the user and instructing the user to provide as an input characters corresponding to the intentionally distorted text. In another embodiment, the step of issuing an attention challenge includes monitoring images of the user to determine that the user is looking at a display of the mobile device to determine that the device is in a driven state. In a further embodiment, the step of modifying restrictions includes imposing restrictions in response to a determined driving state. In another embodiment, the method further includes the step of imposing a restriction on the mobile device prior to the step of issuing an authentication challenge; and wherein the step of modifying restrictions includes removing the imposed restriction in response to determining that the device is in a driven state.

In a second aspect of the present invention, there is provided a mobile device comprising an input, a memory and a processor. The memory stores instructions that are executed by the processor. Upon execution of the instructions, the processor can, responsive to receipt of an indication that the mobile device is subject to travel, issue to the user an attention challenge to determine if the mobile device is in a driving state or a driven state; and modify restrictions applied to mobile device features in accordance with the determined state of the device.

In an embodiment of the second aspect of the present invention, the mobile device further includes a radio access network interface, and the indication is received from a network node over the radio access network interface. In another embodiment, the mobile device includes a display, the input device is a camera, and the attention challenge includes: determining, using input from the camera, that the user is looking at the screen for a sufficient amount time, and responsive to the determination that the user is looking at the screen for a sufficient amount of time, determining that the device is in a driven state. In another embodiment, the mobile device includes a display, the input device is a keyboard, and the attention challenge includes: displaying intentionally distorted text to the user, and instructing the user to provide as an input characters corresponding to the intentionally distorted text. In a further embodiment, the mobile device includes a display, the input device is a touchscreen, and the attention challenge includes displaying a pattern to the user, and instructing the user to move an onscreen element in accordance with the displayed pattern.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flow chart illustrating a method of the prior art;

FIG. 2 is a flow chart illustrating a method of restricting features on a mobile device in response to a differentiation between a driving state and a driven state;

FIG. 3 is a flow chart illustrating an exemplary embodiment of the method of FIG. 2;

FIG. 4 is a flow chart illustrating an exemplary embodiment of the method of FIG. 2;

FIG. 5 is a flow chart illustrating an exemplary embodiment of the method of FIG. 2;

FIG. 6 is a flow chart illustrating an exemplary embodiment of a method of modifying restrictions on a mobile device in response to an attention challenge; and

FIG. 7 is a block diagram illustrating an exemplary mobile device.

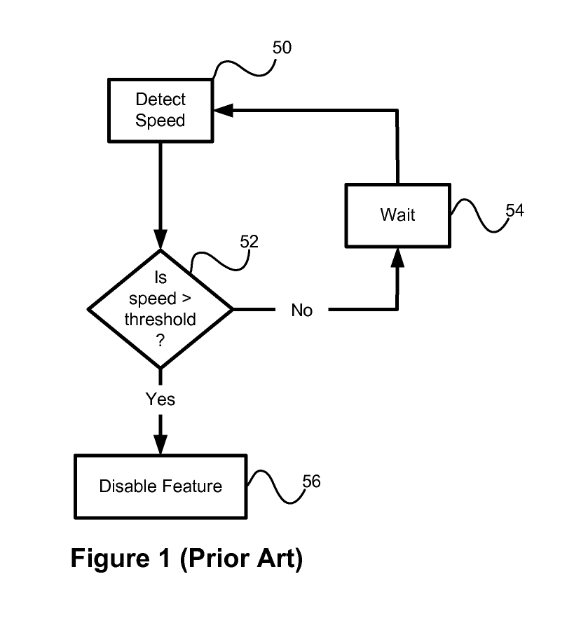

### DETAILED DESCRIPTION

Embodiments of the present invention are directed to a system and method that enables the restriction of features on a mobile device in response to a determination that the device is in a driving state, but allows access to the restricted features if it is determined that the device is in a driven state.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

The present invention allows for a differentiation between a driving and a driven state without requiring explicit specification of the state from the device operator. Once such a determination is made, appropriate restriction of the device can be implemented. One skilled in the art will appreciate that functionally, there is little difference between a scenario in which it is detected that a device has exceeded a speed threshold (putting it into a driving state) and restricting features, only to re-enable features upon determining that regardless of the velocity of the device, the operator is not driving, and a scenario in which a determination that a device is in a driven state instead of a driving state, and the features are never restricted. Both implementations can be used without changing either the user experience or the degree of safety offered. Where only one scenario is discussed below, it should be understood that those skilled in the art will appreciate the minor modifications required to implement the alternate solution.

It is widely recognized that a driver will have different reaction times to external stimuli when using a mobile device in comparison to the same stimuli when not using a mobile device (e.g. the ability to respond to changing traffic conditions deteriorates when a driver is using a mobile device to type a message). It is also apparent that there are differences in the manner in which operators of mobile devices behave when they are driving a vehicle in comparison to the manner in which they behave when they are not driving a vehicle (e.g. the ability to focus on the mobile device screen is impaired by having to drive). In essence, use of a mobile device will serve to distract a driver, but driving a vehicle also serves to distract the user of a mobile device. By detecting the behaviors that indicate that a mobile device user is distracted (e.g. by driving a vehicle), and possibly in conjunction with the use an indicator of vehicular travel such as exceeding a speed threshold (either an instantaneous threshold which would allow for use of a mobile device when a vehicle comes to a stop, or a threshold that makes use of hysteresis so as to prevent the use of a mobile device at stop signs), a mobile device can restrict features for drivers while not preventing the use of the same feature by a passenger sitting beside the driver.

One noted difference between a driver and a passenger is the ability of a passenger to safely focus attention on the mobile device for set periods of time. Drivers have other concerns, including the necessity that the road be monitored. Although a driver may be distracted from paying sufficient attention to the road, it is common for a driver to focus on the road for longer periods of time than are spent focusing on the mobile device. Thus, it should be understood that the use of a challenge that requires the user's attention to respond to, can be used to determine whether a user is otherwise occupied.

The ability of a user to focus on the screen of a mobile device can be correlated to the amount of time in a given time window that the user looks at the screen. Thus, in one embodiment, by setting an attention threshold, expressed as a required amount of time spent looking at the screen, a mobile device is able to determine if the user is too distracted from the device (typically by the operation of a car) to be provided with the full features of the device.

In one embodiment, the mobile device can be equipped with a user facing imaging device such as a camera. To determine if the user meets the focus threshold, the camera can be used to detect whether the user is looking at the screen. The use of a camera to detect that a user is reading, or otherwise looking at, a screen is known in the art, as is the ability of a device to provide limited control to a user based on eye movement. In embodiments of the instant invention, an attention challenge can be implemented as a relatively rudimentary check to determine the percentage of time in a given time window that a user spends looking at the screen. If the percentage exceeds the threshold value, it can be assume that the user is not distracted by operating a vehicle, and thus can safely be provided full functionality of the mobile device regardless of the speed at which the device is moving. One example of a user in this condition would be a user sitting on a train who is trying to compose an email message. The user will be looking at the screen to either read content or to compose the message, and thus will meet the required threshold values. It should be noted that if the user is distracted by watching scenery outside a train window, the device may be temporarily restricted, but in that case, the user will likely not notice and thus will not be inconvenienced. In another example, the user of the mobile device will be distracted by needing to pay attention to road conditions, traffic and vehicle indicators. As such, in any given time window, he will fail to meet the required attention threshold, and keyboards and the handset functionality of the device will be restricted. Those skilled in the art will appreciate that if the amount of time not looking at the screen is measured, exceeding the threshold would constitute failing the attention challenge.

As noted above, it does not necessarily matter if a speed is determined to exceed a threshold, resulting in the locking of features which are then re-enabled if the device detects that sufficient attention is being paid to the device to move the device from a driving state to a driven state (e.g. assume a driving state unless a driven state can be determined) or if the device features are only locked when the device cannot detect sufficient attention (e.g. lock features when a driven state cannot be verified). In embodiments of the instant invention, a mobile device differentiates between a driving state and a driven state. In response to that determination, modifications to restrictions are made. Based on whether features were locked or unlocked, in accordance with the determination, various features can either be locked or unlocked. Both of these states can be triggered by a number of different factors, including determining that a speed has exceeded a predetermined threshold, a Bluetooth pairing with either a particular device or with a class of devices (e.g. pairing with a user's car, or even pairing with any car), or a user initiated driver mode.

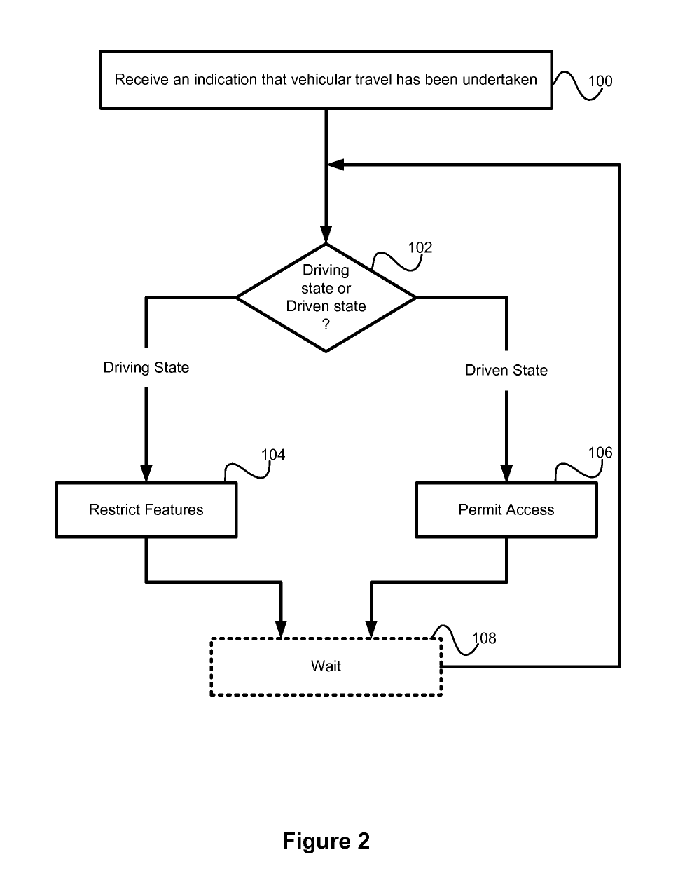

As illustrated in FIG. 2, in an exemplary method of the present invention, an indication is received that the vehicular travel has been undertaken in step 100. Typically, this indication is received from a sensor such as the GPS or the Bluetooth radio, it may also come from a user input. In step 102, a determination is made as to whether the device is in a driving state (e.g. the device operator is also driving the vehicle) or a driven state (e.g. the device operator is not the driver of the vehicle). If a driving state is determined in step 102, the mobile device restricts access to features and possibly applications in step 104. If a driven state is determined in step 102, the mobile device can permit access to the features and applications that would otherwise have been restricted in step 104. Following either of steps 104 or 106, the mobile device may optionally wait for a predetermined amount of time in step 108 and then go back to a point prior to step 102. One skilled in the art will appreciate that where features are not restricted prior to step 102, the result of a determination of a driven state in step 102 may simply proceed to step 108; and similarly, if features are preemptively restricted in advance of step 102, the determination of a driving state in step 102 may simply result in the process proceeding to step 108. One skilled in the art will appreciate that taken together, steps 104 and 106 should be understood as a modification to a restriction in response to the differentiation between a driving and driven state in step 102.

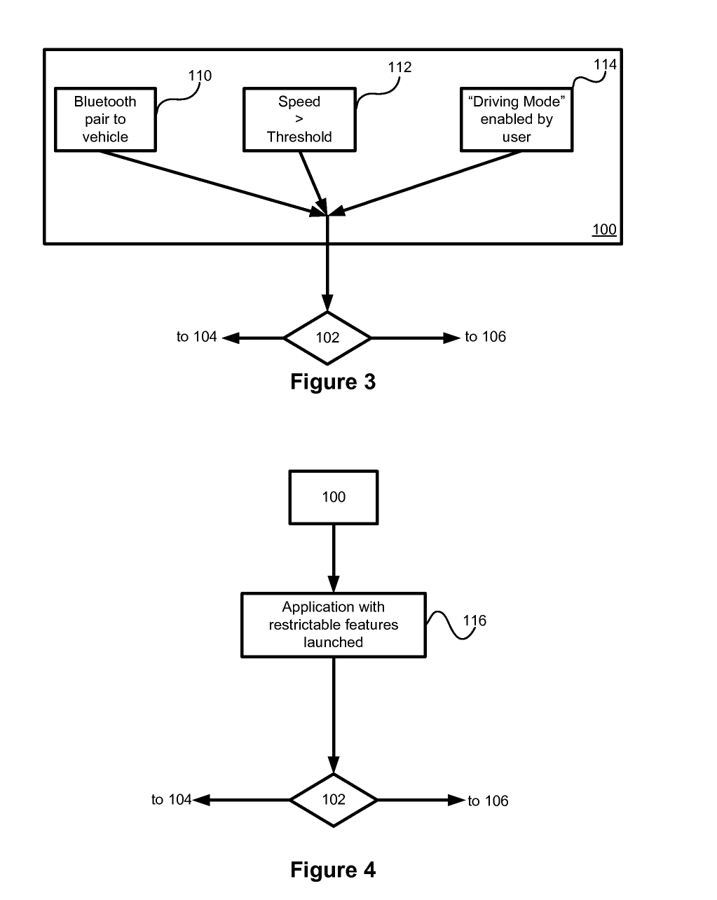

FIG. 3 illustrates an exemplary embodiment in which particular exemplary indications used in step 100 are shown. An indication that the a mobile device is travelling in a vehicle may include the device performing a Bluetooth pairing to a vehicle as shown in step 110, the speed of the vehicle exceeding a threshold in step 112, and an explicit device based driving mode selection being made by the user as shown in step 114. Those skilled in the art will appreciate that the determination of a speed in excess of a threshold may be done either in the mobile device itself through the use of various sensors, such as the GPS, or by a network through the use of location based services. Although shown as parallel indications in FIG. 3, it should be understood that in various embodiments, combinations of these indicators (possibly with other indicators) may be required. As illustrated, following the receipt of the indicator in step 100, the process continues to step 102 as above.

FIG. 4 provides an alternate embodiment in which an optional step is introduced between steps 100 and 102 of FIG. 2. As illustrated in FIG. 4, following step 100, the mobile device detects that an application with restrictable features is launched in step 116. Following this detection, the process continues to step 102. Those skilled in the art will appreciate that the determination of driving vs. driven state may only need to be done when particular applications (e.g. SMS application or a video playing application) are executed, and that performing the determination at other times may simply consume battery resources unnecessarily.

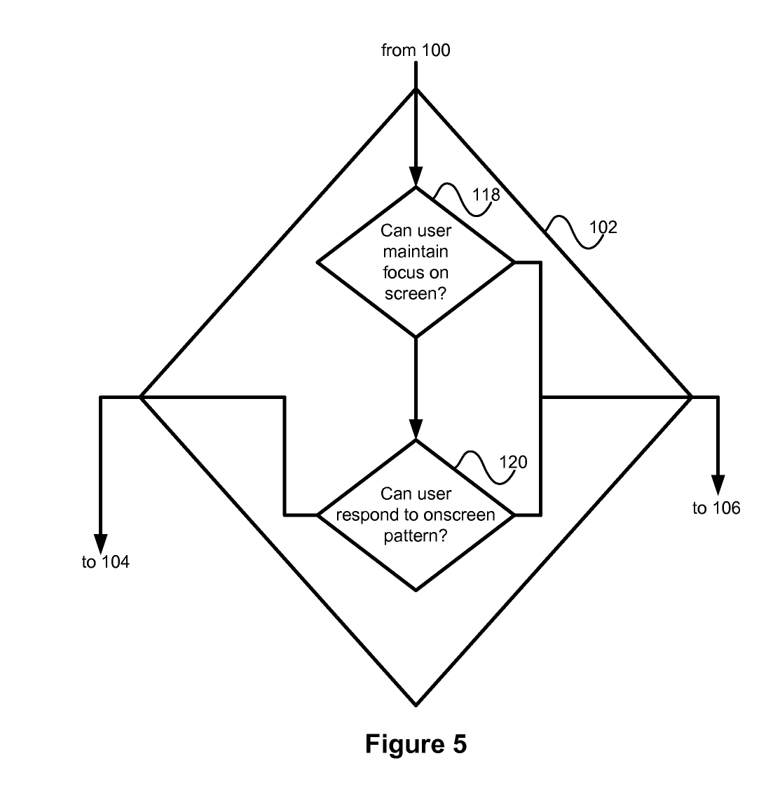

FIG. 5 provides an alternate embodiment of the method shown in FIG. 2, where an attention challenge is provided to the user. In FIG. 5, two different challenges are illustrated, and are shown in series. One skilled in the art will appreciate that as long as one of the challenges is responded to positively, the mobile device can determine a driven state. In some embodiments, only one of the illustrated challenges may be presented to the user.

Following step 100, the mobile device, in step 118, determines if the user is able to maintain a visual focus on the screen for a predetermined amount of time. As discussed above, the visual focus of the user can either be required for a fixed duration, or a percentage of a time window (e.g. 85% of a 5 second window). The visual focus can be measured using a user facing camera. The mobile device processor can make use of known pattern recognition techniques to ensure that the user is looking at the device. Upon successful completion of the challenge in step 118, the mobile device can proceed to the driven state in step 106. If the user fails the attention challenge of step 118, he can be provided with a subsequent attention challenge in step 120. In step 120, an interactive attention challenge can be presented to the user, with a request that the user respond to an onscreen pattern. In one embodiment, the user can be presented with a series of onscreen locations and be asked to trace a path between the locations in a particular order. One skilled in the art will appreciate that it will be preferable that the order is not fixed for all challenges to prevent the user from memorizing a pattern. The full order of the pattern can be presented to the user in one presentation, or the user can be instructed to move an onscreen element from a first location to a second location such as by tracing the presented pattern on the display, and only when the location has been reached will the user be told a third location, etc. To respond to this exemplary onscreen challenge, the user may be required to trace out the provided pattern on a touch screen device within a set amount of time. On a device with a keyboard, a distorted text image, also referred to as a “captcha” may be presented as an onscreen pattern and the user asked to type the distorted text on the keyboard. In a further embodiment of the onscreen pattern challenge of step 120, where the mobile device is capable of performing eye tracking, the user may be asked to follow a moving image with his eyes (e.g. follow the bouncing ball). Upon successful completion of the onscreen pattern based attention challenge of step 120, the device can enter the driven state and proceed to step 106. If the attention challenge of step 120 is failed, a subsequent attention challenge can be presented, or if there are no further attention challenges to preset to the user, the device can enter the driving state and proceed to step 104. It should be noted that any attention challenge may include a time limit, so as to ensure that the use is responding in a short enough time to be able to assume a driven state. One skilled in the art will appreciate that the attention challenges presented, and the order in which thye are presented should not be considered as limiting as they they are presented for exemplary purposes.

As noted above, either an application or a feature in an application can be restricted. A video player may be an example of an application that is restricted, while the keyboard in an SMS application is an example of a feature that may be restricted (thus allowing the user to make use of an audio input).

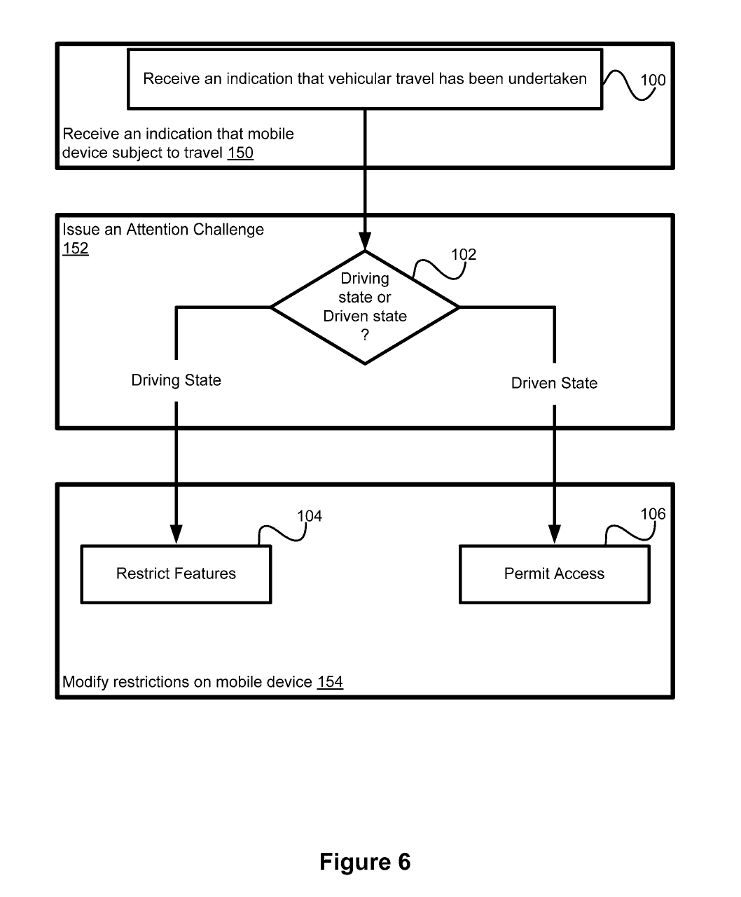

FIG. 6 illustrates an alternate view of the methods described above. In step 150, the mobile device receives an indication that it is subject to travel, this was previously shown in step 100 of FIG. 2. In step 152, an authentication challenge is issued, which corresponds to the determination of a driving or driven state in step 102. In step 154, modifications to restrictions on the mobile device are made, as was previously shown in steps 104 and 106.

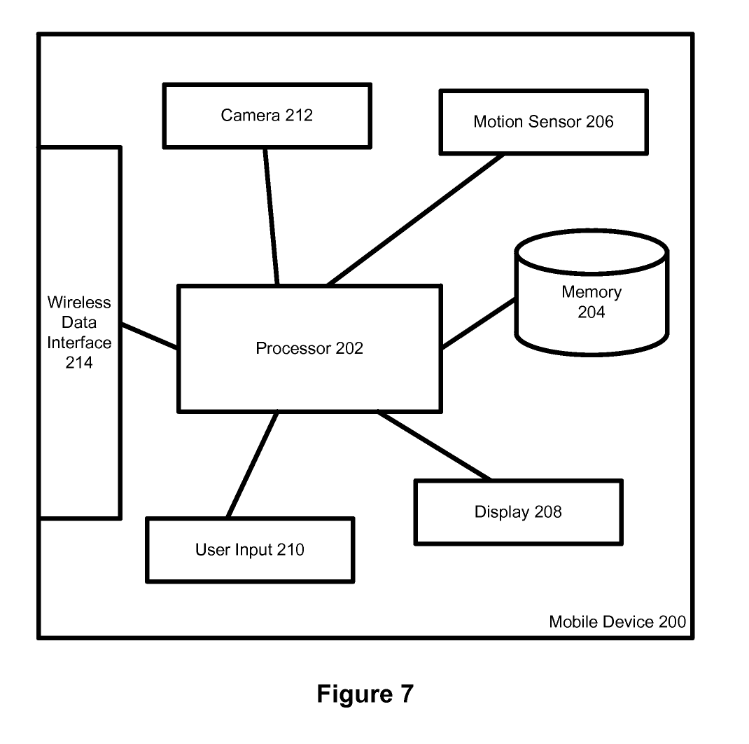

FIG. 7 illustrates an exemplary mobile device of the present invention. Mobile device 200 includes processor 202 and a memory 204. Memory 204 includes both applications and system instructions that are executed by the processor. Motion sensor 206 (such as an accelerometer or a GPS chipset) can provide both an indication that the mobile device is in motion, and an indication that the speed of the device is in excess of the threshold. Display 208 is used to provide information to the user, while user input 210 (which can include a keyboard, a touch screen, and/or an audio input device) can be used in conjunction with the display as part of an attention challenge as discussed above. Embodiments that make use of focus tracking will also preferably include optional camera 212 arranged so that it can track user focus. A wireless data interface 214 may be provided on devices to send and receive messages. In some embodiments interface 214 is a radio access network interface which allows for communication with wireless networks, although it should be recognized that in some devices, interface 214 may be used for short range communication protocols such as Bluetooth and WiFi. Those skilled in the art will appreciate that the motion sensor, the camera, the user input and the wireless data interface 214 can all be understood as being classes of a generic input. The input devices can each be used to provide information to the processor 202 that allows the processor 202 to determine either that the device 200 is in motion or that the user is performing the authentication challenge.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of restricting access to a mobile device in travel, the method carried out at the mobile device comprising:
receiving an indication that the mobile device is subject to travel;
issuing an attention challenge to the user of the mobile device to determine if the device is in a driving state or a driven state; and
modifying restrictions on the mobile device in accordance with the determined state of the device.

2. The method of claim 1 wherein the step of receiving an indication includes receiving the indication from a mobile device sensor.

3. The method of claim 2 wherein the step of receiving an indication includes receiving an indication that the device has connected to a vehicle.

4. The method of claim 3 wherein the indication is an indication that the mobile device has connected to a vehicle using a Bluetooth connection.

5. The method of claim 2 wherein the step of receiving an indication includes receiving an indication from the user that the mobile device is subject to travel.

6. The method of claim 2 wherein the step of receiving includes receiving an indication that a threshold speed has been exceeded by the mobile device.

7. The method of claim 6 wherein the step of receiving includes computing a speed in accordance with location information.

8. The method of claim 1 wherein the step of receiving an indication includes receiving the indication from a network entity over a radio access network.

9. The method of claim 1 further including the step of determining that an application subject to restrictions has been launched.

10. The method of claim 1 wherein the step of issuing an attention challenge includes displaying instructions to the user to provide an input to the mobile device and in accordance with a received input from the user determining the device to be in a driven state.

11. The method of claim 10 wherein the step of displaying instructions to the user includes displaying intentionally distorted text to the user and instructing the user to provide as an input characters corresponding to the intentionally distorted text.

12. The method of claim 1 wherein the step of issuing an attention challenge includes monitoring images of the user to determine that the user is looking at a display of the mobile device to determine that the device is in a driven state.

13. The method of claim 1 wherein the step of modifying restrictions includes imposing restrictions in response to a determined driving state.

14. The method of claim 1 further including the step of imposing a restriction on the mobile device prior to the step of issuing an authentication challenge; and wherein the step of modifying restrictions includes removing the imposed restriction in response to determining that the device is in a driven state.

15. A mobile device comprising:
an input;
a processor executing instructions; and
a memory for storing instructions that when executed by the processor cause the processor to:
responsive to receiving an indication that the mobile device is subject to travel, issuing to the user an attention challenge to determine if the mobile device is in a driving state or a driven state; and
modifying restrictions applied to mobile device features in accordance with the determined state of the device.

16. The mobile device of claim 15 wherein the mobile device further includes a radio access network interface, and the indication is received from a network node over the radio access network interface.

17. The mobile device of claim 15 further including a display,
wherein the input device is a camera, and
wherein the attention challenge includes:
determining, using input from the camera, that the user is looking at the screen for a sufficient amount time, and
responsive to the determination that the user is looking at the screen for a sufficient amount of time, determining that the device is in a driven state.

18. The mobile device of claim 15 further including a display,
wherein the input device is a keyboard, and
wherein the attention challenge includes:
displaying intentionally distorted text to the user, and
instructing the user to provide as an input characters corresponding to the intentionally distorted text.

19. The mobile device of claim 15 further including a display,
wherein the input device is a touchscreen, and
wherein the attention challenge includes:
displaying a pattern to the user, and
instructing the user to move an onscreen element in accordance with the displayed pattern.
